(19) United States
(12) Patent Application Publication
(10) Pub. No.: US 2004/0051745 A1
(43) Pub. Date: Mar. 18, 2004

(54) System and method for reviewing a virtual 3-D environment

(76) Inventor: Ullas Gargi, Mountain View, CA (US)

Correspondence Address: HEWLETT-PACKARD COMPANY, Intellectual Property Administration, P.O. Box 272400, Fort Collins, CO, 80527-2400, US

(21) Appl. No.: 10/247,221

(22) Filed: Sep. 18, 2002

(51) Int. Cl. G09G 5/00

(52) U.S. Cl. 345/850; 345/704

(57) ABSTRACT

A method for reviewing a virtual 3-D environment is disclosed. In one embodiment, a persistent virtual 3-D environment is generated. Additionally, all virtual activity taking place in the persistent virtual 3-D environment is recorded. The recording of the virtual activity is then stored in a central location. In so doing, the virtual activity in the persistent virtual 3-D environment may then be replayed, wherein the replaying may be performed by remote access.

### TECHNICAL FIELD

The present claimed invention relates to the field of virtual 3-D environments. Specifically, embodiments of the present invention relate to a system and method for reviewing a virtual 3-D environment.

### BACKGROUND ART

Presently, there are many types of virtual 3-D environments. These virtual 3-D environments are used for gaming, role-playing, business collaboration, and social interaction. In fact, the utilization of virtual 3-D environments is becoming commonplace. Many virtual 3-D environments are complete “worlds” or persistent environments.

In a virtual 3-D environment, people may be represented by a virtual being known as an avatar. In general, an avatar may be an indistinguishable body figure having a unique face. Thus, the virtual environment does not need to “reinvent” each character, but may instead utilize a generic “being” with uniquely identifying facial features. Such a characterization may save both processing speed and memory space.

In general, people (or their avatars) may enter and leave virtual 3-D environments (or worlds) asynchronously but the world itself will persist in the memory of the server computer hosting the virtual environment.

As virtual environments become imbued with the characteristics of the physical world, (e.g., utilizing avatars having the same face/body model of the people they represent), a user or group of users may desire to interact in the virtual environment in much the same way that is done in the normal world. For example, a group of users wishing to have a virtual meeting may desire to have the meeting in a virtual room similar to that of a conference or meeting room. Utilizing a business format for the virtual environment may help reinforce the social formality and etiquette normally associated with a business meeting. Additionally, by utilizing a recognizable format, the efficiency of the group participating in the virtual meeting may be increased.

One deleterious effect of utilizing the virtual meeting room is a lack of further dissemination of any information obtained in the meeting. For example, if a person cannot make the virtual meeting due to sickness, other engagement, etc., they have no effective way of reviewing any events that took place. The use of a video or tape recorder would be an unacceptable means for reviewing the virtual events.

What is needed is a technique for reviewing events that occurred in a 3-D interactive environment. A further need exists for a technique for reviewing the events that occurred in a 3-D interactive environment which includes the ability to review content introduced by an outside source. Another need exists for a technique for reviewing events that occurred in a 3-D interactive environment which may be viewed from a plurality of viewpoints.

### SUMMARY OF THE INVENTION

A method for reviewing a virtual 3-D environment is disclosed. In one embodiment, a persistent virtual 3-D environment is generated. Additionally, all virtual activity taking place in the persistent virtual 3-D environment is recorded. The recording of the virtual activity is then stored in a central location. In so doing, the virtual activity in the persistent virtual 3-D environment may then be replayed, wherein the replaying may be performed by remote access.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a representation of an exemplary virtual 3-D environment in accordance with one embodiment of the present invention.

FIG. 2 is a block diagram of an exemplary computer network for reviewing a virtual 3-D environment in accordance with one embodiment of the present invention.

FIG. 3 is a flowchart of an exemplary method for reviewing a virtual 3-D environment in accordance with one embodiment of the present claimed invention.

The drawings referred to in this description should be understood as not being drawn to scale except if specifically noted.

### BEST MODES FOR CARRYING OUT THE INVENTION

Reference will now be made in detail to embodiments of the invention, examples of which are illustrated in the accompanying drawings. While the invention will be described in conjunction with the embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, the present invention may be practiced without these specific details. In other instances, well-known methods, procedures, components, and circuits have not been described in detail as not to unnecessarily obscure aspects of the present invention.

In order to promote normal interaction modes, virtual worlds are imbued with many characteristics of the physical world (e.g., avatars having the same body/face model of the people they represent in order that people are polite to them). It is therefore logical that users of a virtual environment will want to interact with it in much the same way as they do within the non-virtual world. In particular, people may want to know what happened in a virtual room or virtual world while they were absent, or while people from other time zones visited. Embodiments of the present invention provide this capability. In essence, the present invention, in its various embodiments, provides the capability to videotape virtual reality.

In one embodiment, a virtual camera can be placed at any arbitrary location within a virtual scene. The location can be arbitrary because having a camera at a point just means synthesizing a 3-D view from that point. In fact, there may be an arbitrary number of virtual cameras placed anywhere and pointing anywhere. Moreover, the choice of camera location may be made by a human user at runtime while reviewing a history of the virtual world. However, rules of the virtual world may dictate only certain allowable positions. For example, there may be locations in the virtual world that are held as private. Also, objects in the virtual world may be opaque.

In the present embodiment, the virtual cameras record the virtual scene and any activities that occur in the virtual room (world). If there are no active participants, or no other ongoing activities, the scene may be elided. Additionally, a human user may later choose to review the activities occurring in the world during a specific time and be served a “video” showing the events, either pre-recorded or generated dynamically as stated herein.

Pre-recorded virtual video may not have the format of conventional video (e.g., analog or digital). For example, it may be highly compressed and accessed merely by referencing an index (or identifier) associated with the virtual room or world, and a time index. Together, these will serve to define the persistent objects of the scene that can then be completely reconstructed from their 3-D models. The active participants in a scene may also be represented by an avatar index and time, which will serve to be able to reconstruct that avatar as it was recorded at the desired time. Furthermore, there may be avatars or objects from other virtual worlds that can be represented by indexing their object entry in the appropriate peer server database.

In addition, there may be participants or content from external worlds or external entities (e.g., physical objects that are introduced into the virtual environment, e.g., by plugging live video into the virtual world to show home movies) that cannot be compressed by referencing an object in an environment server database because it does not exist therein. In this case, these objects may be compressed by conventional means—image, video, or audio compression for digital media and 2-D or 3-D models, or 2-D or 3-D image-based models for physical objects that are introduced into the world (e.g., by a scanner, camera, 3-D scanner). Therefore, during playback, the user can view a richly annotated index of events, utilize random access, view and/or read complete transcripts, look-up unknown persons, etc.

Furthermore, during playback, the user may choose to interface two or more recordings of virtual activity such that both recordings are played in conjunction. For example, while reviewing a virtual meeting, the user may also review an activity occurring in a second virtual environment and/or activity that may or may not correlate with the initial viewing environment (e.g., a personal virtual environment, another meeting taking place at the same time, the same presentation being given at a different time to a different group, or the like). Thus, the present embodiment allows for a user centric nesting capability that may allow the user to switch context during playback.

Additionally, a prompt may be established to alert a user reviewing a virtual activity to access another virtual world in real time or another recording of other virtual activity. For example, if a user is reviewing a virtual recording, an alert (e.g., noise, light, signal, or the like) may be used to inform the user of real time activity taking place in the virtual environment being reviewed. Moreover, the alert may inform the user of real time activity taking place (or recorded activity that took place) in a different virtual environment than the one being reviewed.

It is also appreciated that features of the present invention may be utilized while a user is participating in a virtual activity in real time. For example, while a user is participating in a virtual meeting, a prompt may be used to alert the user of another, ongoing virtual meeting that the user may view or participate in. The user may decide to “leave” his/her virtual meeting to participate in the other, or the user may participate in each virtual meeting in parallel. As another example, a user may review a recording of an earlier virtual activity while participating in another virtual meeting in real time.

Thus, the present embodiment allows people who visit persistent virtual 3-D environments to see a quick encapsulation of events that occurred in an environment while they were absent in much the same way as videotaping an event allows people who weren't present to view it, with the natural advantages offered by virtual recordings (e.g., complete knowledge of the environment, accurate personal recognition, multiple viewpoints, remote access, nothing-happening auto-delete, etc.).

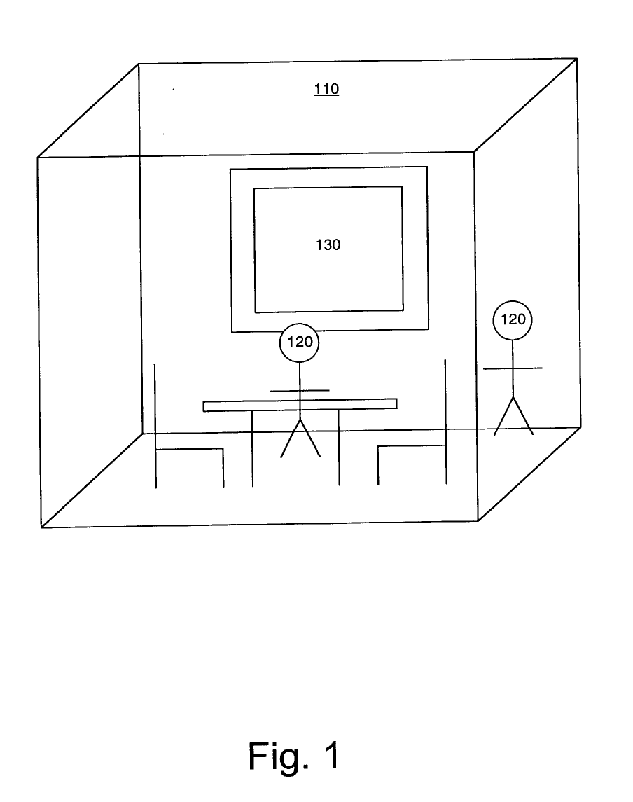

With reference now to FIG. 1, a representation of an exemplary virtual 3-D environment 100 is shown in accordance with one embodiment of the present invention. In one embodiment, virtual 3-D environment 100 includes persistent virtual 3-D environment 110, avatars 120, and content 130.

Persistent virtual 3-D environments are known in the art. Generally speaking, persistent virtual 3-D environment 110 may be rendered as a virtual environment and stored simply as a specific location. For example, the persistent virtual 3-D environment 110 shown in FIG. 1 represents a meeting or conference room. As such, the persistent virtual 3-D environment 110 may include walls, a table, chair, and the like. It is appreciated that virtual 3-D environment 110 may also include avatars that are persistently present in the virtual world. By utilizing a persistent virtual 3-D environment 110 that has familiar surroundings that mirror actual reality, “real world” social etiquette is more easily accepted by users participating in the virtual world.

In addition to establishing a scenario that mirrors the “real world,” persistent virtual 3-D environment 110 may also be stored only once on a computing system. For example, when a virtual business meeting takes place in persistent virtual 3-D environment 110, the recording of the meeting does not need to include persistent virtual 3-D environment 110. Only the dynamic virtual activity needs to be recorded. Then, during review (e.g., at a later time) the computer system can simply overlay any dynamic virtual activity over the persistent virtual 3-D environment 110. Thus, a large portion of the memory and processing power of the computer system may not be inundated with superfluous information.

With reference still to FIG. 1, avatars 120 are virtual representations of persons in the real world. In general, avatars 120 may be featureless humanoid figures that have recognizable features overlaid. For example, an avatar 120 may have a person's face placed upon an otherwise generic body. The recognizable features are used in conjunction with the generic body to establish a form of recognition between the “virtual” person and the actual person. Although a facial recognition system is utilized herein, avatars 120 may utilize many forms of recognition such as body features, name tags, iconic representations, or the like. The use of facial recognition in the present embodiment is merely for purposes of brevity and clarity. Additionally, avatars 120 may be native avatars 120 (e.g., exist in the persistent virtual 3-D environment) and/or non-native avatars 120 (e.g., guest).

Content 130 may be any activity that can be recorded and introduced from outside the virtual world. In general, content 130 includes content introduced by an outside source such as joint photographic experts group (JPEG), moving pictures experts group (MPEG), slide, video, picture, photograph, 2-D model of an external object, and 3-D model of an external object, introduced by an outside source, and the like. In addition, images and/or video may be grabbed from a camera/scanner, images and/or video may be sent to a 2-D or 3-D printer, or the like.

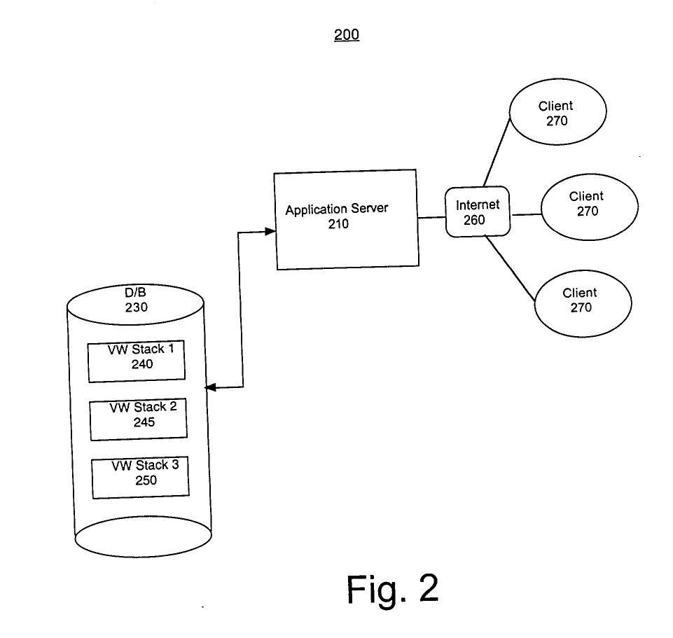

Referring now to FIG. 2, a block diagram of a computer network 200 for reviewing a virtual 3-D environment is shown in accordance with one embodiment of the present invention. Specifically, network 200 shows virtual world stacks (e.g., 240-250), database 230, application server 210, Internet connection 260, and clients 270. In general, the present embodiment is one of a plurality of possible methods for utilizing a computer system 200 for reviewing a virtual 3-D environment. It should be noted that although network 200 is depicted as a number of distinct components (e.g., components 210-270), embodiments of the present invention are well suited for use on a single device, single database, or a multiplicity of devices and/or databases, such as, for example, the Internet.

Initially, as shown in network 200, a client 270 may access an application server 210. In one embodiment, the access may occur utilizing the Internet 260. Furthermore, client 270 may be a single device, a plurality of devices, a network, a terminal, 3-D glasses, or the like, which may desire and/or require access to application server 210. Additionally, although an Internet 260 connection is shown as the platform for a client 270 to access application server 210, the platform may be a local area network (LAN), wide area network (WAN), Ethernet, wireless network, or the like which can connect a single user or multiple users to an application server 210.

Application server 210 may be any type of system that accesses a database 230. For example, application server 210 may utilize an application to search a database such as database 230 for virtual 3-D environments, such as virtual world (VW) stack 1 240, VW stack 2 245, VW stack 3 250, or the like which may contain the desired recording of virtual activity. In the present embodiment, application server 210 may be a global application server that has access to database 230.

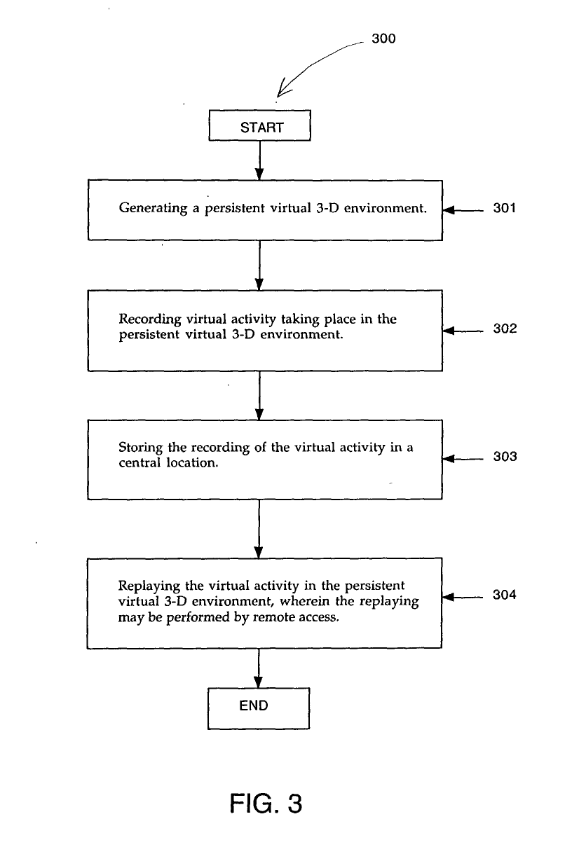

In one embodiment, the processes described herein, for example, in flowchart 300 of FIG. 3, are comprised of computer readable and computer executable instructions which reside in data storage features of a generic computer system. The generic computer system includes, for example, non-volatile and volatile memory, a bus, architecture, and a processor. Further, the computer-readable and computer-executable instructions are used to control, or operate in conjunction with, the processor.

With reference now to FIG. 3, a flowchart of an exemplary method for reviewing a virtual 3-D environment is shown. With reference now to step 301 of FIG. 3, a persistent virtual 3-D environment is generated. As stated herein, persistent virtual 3-D environment 110 may be any type of environment, such as a room, a forest, a park, or the like, that can be programmed once and retains its persistency regardless of when it is accessed. Alternatively, the environment may be generated, created, built, or the like, using persistent components programmed once and stored.

With reference now to step 302 of FIG. 3, the virtual activity taking place in the persistent virtual 3-D environment 110 (FIG. 1) is recorded. As stated herein, the recording may be of any virtual activity, such as between avatars 120, a speech by a single avatar 120, content introduced by an outside source, or the like. In one embodiment, the virtual activity is dynamic (e.g., streamed data which is recorded as such). Additionally, the recording may include state information such as who was present, how the room was laid out, objects that were present, position of objects that were present, any motion, any audio, any extended media (e.g., content 130), and/or the like.

In addition to recording the virtual activity, the present embodiment may further index the virtual activity taking place in persistent virtual 3-D environment 110 and/or add a time stamp to the recording. In general, the time stamp is utilized to simplify a search for a desired recording. For example, if replay of an event is desired, the user identifies the persistent virtual 3-D environment 110 and the time of interest, and the corresponding recording is accessed.

The present embodiment may further index and/or time stamp each specific avatar 120 taking part in the virtual activity. Therefore, if the activities of a specific avatar are of interest, that avatar can be located in each of the various virtual worlds that may exist. Also, if a specific statement, action, gesture, and/or the like, made by a specific avatar 120 is desired for review, a user may simply index avatar 120 for a specific time and review any virtual activity performed by the avatar 120. Additionally, the user may choose to view avatar 120 with or without the presence of persistent virtual 3-D environment 110.

With reference still to step 302 of FIG. 3, the present embodiment may further index and/or time stamp each specific content 130 associated with the virtual activity. Therefore, if a specific content, or portion of content, is desired for review, a user may index content 130 for a specific time. Additionally, the user may choose to view content 130 with or without the presence of persistent virtual 3-D environment 110 and/or avatars 120.

With reference now to step 303 of FIG. 3, the recording of the virtual activity may be stored in a central location. For example, with reference also to FIG. 2, the virtual activity (e.g., VW stack 1 240) may be stored, cataloged, archived, or the like in a database 230. In addition to storing the virtual activity, periods of the recording of virtual activity in which no activity is taking place may be deleted. In one embodiment, the virtual activity may be stored in integral representation.

With reference now to step 304 of FIG. 3, the virtual activity in conjunction with persistent virtual 3-D environment 110 may be replayed. Furthermore, the replay, review, reenactment, or the like, of the virtual activity may be performed by remote access. Additionally, the access may be by any user with access to the database 230 and more specifically the VW stack. The user desiring access may or may not have been involved in the virtual activity being replayed.

In addition to being able to review a virtual activity, the recording may have 100 percent voice recognition. This is possible since the microphone or device that transmitted the voice utilized by the avatar came from a specific computer. That computer, and hence the associated user, can be identified. In the same regard, perfect person recognition (e.g., who attended the meeting) is also possible. Moreover, in both a business setting and a gaming setting, a prospective partner or opponent may utilize the recorded virtual activity to evaluate a specific persons', or group of persons', previous actions, past performances, skill set and/or the like.

Thus, the present embodiments provide a system and method for reviewing a virtual 3-D environment. Additionally, the present embodiments provide a system and method for reviewing a virtual 3-D environment which further allows people who visit persistent virtual 3-D environments to see a quick encapsulation of virtual activity or events that occurred at earlier times in the virtual environment. The present embodiments further provide a system and method for reviewing a virtual 3-D environment that allow review with the natural advantages offered by virtual recordings (e.g., complete knowledge of the environment, accurate personal recognition, nothing-happening auto-delete, etc).

The foregoing descriptions of specific embodiments of the present invention have been presented for purposes of illustration and description. They are not intended to be exhaustive or to limit the invention to the precise forms disclosed, and modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A method for reviewing a virtual 3-D environment comprising:
generating a persistent virtual 3-D environment;
recording virtual activity taking place in said persistent virtual 3-D environment, including content selected from the group consisting essentially of JPEG, MPEG, slide, video, picture, photograph, 2-D model of an external object, and 3-D model of an external object, introduced by an outside source;
storing said recording of said virtual activity in a central location; and
replaying said virtual activity in said persistent virtual 3-D environment, wherein said replaying may be performed by remote access.

2. The method as recited in claim 1 further comprising:
deleting periods of said recording of virtual activity in which no activity is taking place.

3. The method as recited in claim 1 further comprising:
indexing said virtual activity taking place in said persistent virtual 3-D environment; and
adding a time stamp to said recording, wherein said time stamp simplifies a search for a desired recording.

4. The method as recited in claim 1 wherein said virtual activity being recorded includes an avatar representing a participant in said persistent virtual 3-D environment.

5. The method as recited in claim 4 further comprising:
time-stamping said avatar; and
indexing said avatar for identification purposes.

6. The method as recited in claim 1 further comprising:
indexing said content for identification purposes.

7. The method as recited in claim 1 further comprising:
interfacing two or more recordings of said virtual activity such that both said recordings are replayed in conjunction.

8. The method as recited in claim 1 further comprising:
generating a prompt to alert a user to access another virtual world in real time.

9. A computer system comprising:
a bus;
a memory unit coupled with said bus; and
a processor coupled with said bus, said processor for reviewing a virtual 3-D environment comprising:
creating a persistent virtual 3-D environment;
recording virtual activity taking place in said persistent virtual 3-D environment, wherein said virtual activity being recorded includes an avatar representing a participant;
archiving said recording of said virtual activity in a central location, wherein periods of said recording of virtual activity in which no activity is taking place are not archived; and
reviewing said virtual activity in said persistent virtual 3-D environment, wherein said reviewing may be performed by remote access.

10. The computer system of claim 9 further comprising:
indexing said virtual activity taking place in said persistent virtual 3-D environment; and
adding a time stamp to said recording, wherein said time stamp simplifies a search for a desired recording.

11. The computer system of claim 9 wherein said virtual activity taking place in said persistent virtual 3-D environment is an audio interaction involving said avatar.

12. The computer system of claim 9 wherein said virtual activity taking place in said persistent virtual 3-D environment is a physical gesture of said avatar.

13. The computer system of claim 9 wherein said virtual activity being recorded includes content introduced by an outside source.

14. The computer system of claim 13 wherein said content is selected from the group consisting essentially of JPEG, MPEG, slide, video, picture, photograph, 2-D model of an external object, and 3-D model of an external object.

15. The computer system of claim 13 further comprising:
indexing said content for identification purposes; and
time-stamping said content.

16. The computer system of claim 9 further comprising:
interfacing two or more recordings of said virtual activity such that both said recordings are replayed in conjunction.

17. The computer system of claim 9 further comprising:
generating a prompt to alert a user to access another virtual world in real time.

18. A computer-usable medium having computer-readable program code embodied therein for causing a computer system to perform a method for reviewing a virtual 3-D environment comprising:
building a persistent virtual 3-D environment;
recording virtual activity taking place in said persistent virtual 3-D environment, wherein said virtual activity being recorded includes an avatar representing a participant;
indexing said recording of said virtual activity;
adding a time stamp to said recording;
cataloging said recording of said virtual activity in a central location, wherein periods of said recording of virtual activity in which no activity is taking place are not cataloged;
reenacting said virtual activity in said persistent virtual 3-D environment, wherein said reenacting may be performed by remote access;
interfacing two or more recordings of said virtual activity such that both said recordings are replayed in conjunction; and
generating a prompt to alert a user to access another virtual world.

19. The computer-usable medium of claim 18 wherein said virtual activity taking place in said persistent virtual 3-D environment is an audio interaction involving said avatar.

20. The computer-usable medium of claim 18 wherein said virtual activity taking place in said persistent virtual 3-D environment is a physical gesture of said avatar.

21. The computer-usable medium of claim 18 wherein said virtual activity being recorded includes content introduced by an outside source.

22. The computer-usable medium of claim 21 wherein said content is selected from the group consisting essentially of JPEG, MPEG, slide, video, picture, photograph, 2-D model of an external object, and 3-D model of an external object.

23. The computer-usable medium of claim 21 further comprising:
indexing said content for identification purposes; and
time-stamping said content.

24. The computer-usable medium of claim 18 wherein said generating of said prompt alerts a user to access another recording of a virtual world.

25. The computer-usable medium of claim 18 wherein said generating of said prompt alerts a user to access another virtual world in real time.
